(19) United States
(12) Patent Application Publication
(10) Pub. No.: US 2019/0291299 A1
(43) Pub. Date: Sep. 26, 2019

(54) WOOD CHOPPER DEVICE FOR CUTTING AND SPLITTING WOOD

(71) Applicant: Roald Kverneland, Kirkenes (NO)

(72) Inventor: Roald Kverneland, Kirkenes (NO)

(21) Appl. No.: 16/245,371

(22) Filed: Jan. 11, 2019

(30) Foreign Application Priority Data
Mar. 23, 2018 (NO) 20180414

(51) Int. Cl. B27L 7/00; B26D 1/10; B26D 7/01

(52) U.S. Cl. CPC B27L 7/00; B26D 2007/0043; B26D 7/01; B26D 1/10

(57) ABSTRACT

Device for cutting and/or splitting wood is disclosed. The device comprises a stationary blade co-operating with a reciprocating blade disposed at a front end of a frame, a rear blade having a splitting edge disposed at a rear end of the frame, a movable unit coupled to the reciprocating blade is configured to move along a linear path disposed on the frame. A drive means coupled to the movable unit moves the movable unit forward for moving the reciprocating blade so that a wood received into an aperture of the blade is cut when the reciprocating blade moves pasts the stationary blade. The drive means moves the movable unit rearward for pushing the wood there along the path towards the rear blade for splitting of wood by splitting edge.

### CROSS REFERENCE TO RELATED APPLICATION

The present application claims the benefit of Norway Patent Application No. 20180414 filed Mar. 23, 2018, the contents of which is hereby incorporated by reference

### BACKGROUND OF THE INVENTION

### A. Technical Field

The invention disclosed herein generally relates to a wood cutting machines. More particularly, the invention disclosed herein relates to a wood chopper device configured to cut and/or split wood or the like.

### B. Description of Related Art

Energy cost have been increased sharply in recent years and indications are that prices will continue to increase in future. To reduce income spent on energy, households depends on biomass fuels such as firewood. Fireplaces is found in remote areas where conventional sources of power are unavailable. Also, fireplaces are being used as both a decorative part of the home and as a supplementary heat source during the winter. A problem encountered by residentials utilizing fireplaces is high cost of firewood. So, people prefers to make their own firewood by cutting trees into logs of the desired length and then splitting the logs lengthwise to form the split fireplace logs. Cutting firewood can be a very worthwhile and rewarding experience if done properly. If it is done improperly without regard to safe cutting techniques, serious injury, or death can result.

Generally, hand tools are utilized to cut firewood. Hand tools includes saws, axes, wedges and sledgehammers. Blades of handsaws and axes need to be maintained in sharp and good condition and also need to be certain that all handles are firmly attached to the blade. Utilizing hand tools to cut firewood require large amount of manual power. Power tools are developed to reduce manual labor required for cutting firewood by hand tools, which includes gasoline and hydraulic powered and wood splitter. However, power tool consumes large amount of power. Further some power tool could be only used for cutting logs. Further some other power tools could be only used for splitting of wood.

A prior art, WO 2005/072924 A1 of Tarmo Pitkäniemi, discloses a cutting and splitting device for cutting and splitting tree trunks. The device comprises a frame, a stationary blade having a cutting edge along an aperture in the blade, and a reciprocating blade having a cutting edge, a rear splitting blade having a splitting edge disposed at a rear end of the frame, a movable unit coupled to the reciprocating blade is configured to move along a linear path disposed on the frame, and a drive means coupled to the movable unit. The drive means moves the movable unit forward for moving the reciprocating blade so that a length of wood received in the stationery blade is cut off when the reciprocating blade is moved past the stationary blade. However, the device lacks to provide an improved reciprocating blade with an aperture disposed therein for cutting wood or the like.

In the light of above-mentioned problems, there is a need for a low power consumption wood chopper device, which could perform both cutting and splitting operation of wood.

### SUMMARY OF THE INVENTION

A wood chopper device for cutting and/or splitting wood or the like is disclosed. The wood chopper device comprises a frame, a stationary blade co-operating with a reciprocating blade, a rear blade, a movable unit and a drive means. The stationary blade co-operating with the reciprocating blade disposed at a front end of the frame. The stationary blade comprises a first cutting edge along an edge of a first aperture disposed therein. The reciprocating blade having a second cutting edge along an edge of a second aperture disposed therein. The rear blade having a splitting edge disposed at a rear end of the frame. The movable unit coupled to the reciprocating blade is configured to move along a linear path disposed on the frame. The reciprocating blade coupled to the movable unit by a shaft. The drive means coupled to the movable unit, wherein the drive means is configured to move the movable unit forward and rearward along the linear path. The wood chopper device further comprises two or more wheels beneath the frame to facilitate movement and to provide stability to the chopper. In another embodiment, the first and second cutting edge made of steel is extremely sharp with a hedge against each other to perform cutting action. The stationary blade or fixed knife is affixed at the front of the frame. The reciprocating blade or movable knife is adapted to move by actuation of the movable unit.

In an embodiment, the first aperture could be of various shapes including, but not limited to, circular, rectangular, square or oval shape. In an embodiment, the second aperture could be of various shapes including, but not limited to, circular, rectangular, square or oval shape. The wood chopper device further comprises a mechanical assembly disposed at a side of the frame, configured to operate by a user to perform at least anyone of a cutting or splitting operation. In an embodiment, the stationary blade, rear blade and reciprocating blade are made of high quality steel. In an embodiment, the drive means moves the movable unit forward for moving the reciprocating blade so that a length of wood received in the first and second aperture is cut when the second cutting edge moves past the first cutting edge. In an embodiment, the drive means moves the movable unit rearward for pushing the at least one wood piece there along the linear path to split by the splitting edge of the rear blade.

In an embodiment, the cutting operation of the wood performed by the wood chopper device is disclosed. An appropriate length of wood is fed into the stationary blade and the reciprocating blade in such a way the length of wood extends from the first aperture to the second aperture. Then the mechanical assembly is operated by the user to initiate cutting operation of the wood. The drive means then moves the movable unit forward, which in turn moves the reciprocating unit via the shaft. When the reciprocating blade passes the stationary blade or fixed knife, the second cutting edge crosses the fixed first cutting edge to cut the wood placed therein the aperture.

In an embodiment, the splitting operation of the wood performed by the wood chopper device is disclosed. A piece of wood is placed along the linear path at the rear end of the frame. The user then operates the mechanical assembly to move the movable unit rearward, that is towards the rear blade of the wood chopper device. The movable unit forces the individual piece of wood or log in the linear path passageway against the splitting edge of the rear blade. The splitting edge of the rear blade hits the piece of wood and begins to penetrate it. This operation enables splitting of the wood.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 exemplarily illustrates a right-side perspective view of the wood chopper device in an embodiment of the present invention.

FIG. 2 exemplarily illustrates a left-side perspective view of the wood chopper device in an embodiment of the present invention.

FIG. 3 exemplarily illustrates cutting of wood by the wood chopper device in an embodiment of the present invention.

FIG. 4 exemplarily illustrates splitting of wood by the wood chopper device in an embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

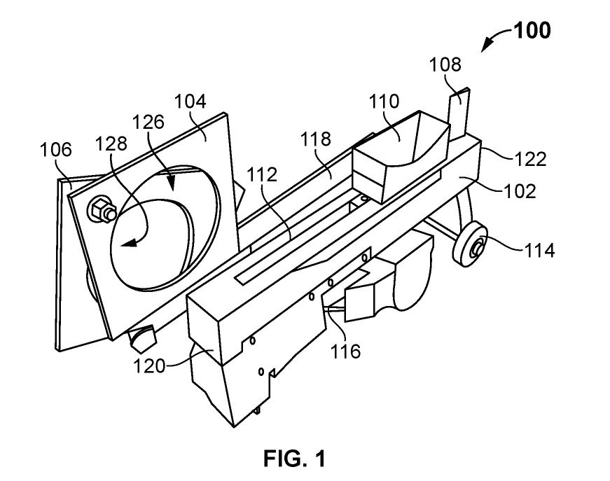

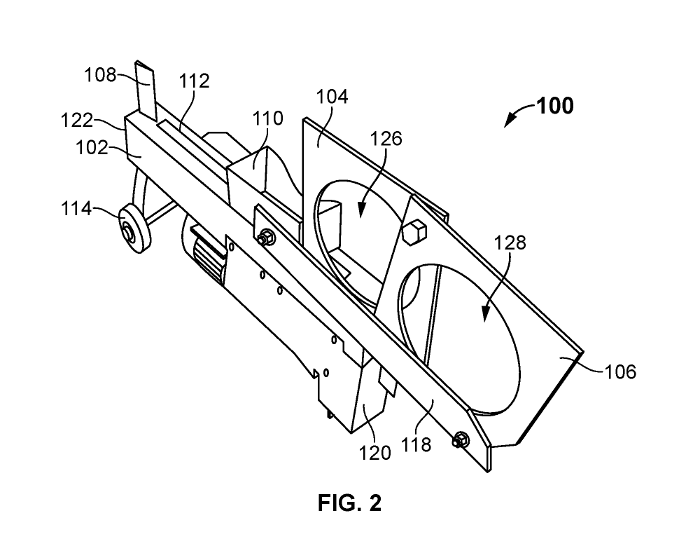

Referring to FIGS. 1 and 2, a wood chopper device 100 for cutting and/or splitting wood or the like, is illustrated. The wood chopper device 100 comprises a frame 102, a stationary blade 104 co-operating with a reciprocating blade 106, a rear blade 108, a movable unit 110 and a drive means. The stationary blade 104 co-operating with the reciprocating blade 106 is disposed at a front end 120 of the frame 102. The stationary blade 104 comprises a first cutting edge along an edge of a first aperture 126 disposed therein. In an embodiment, the first aperture 126 could be of circular, rectangular, square, oval shape or any other shape. The reciprocating blade 106 having a second cutting edge along an edge of a second aperture 128 disposed therein. In an embodiment, the second aperture 128 could be of circular, rectangular, square, oval shape, or any other shape. In In one embodiment, a piece of wood needs to be cut is fed across the first and second apertures (126, 128). The first and second cutting edge is configured to cut the wood on operating the device 100. In another embodiment, the first and second cutting edge made of steel is extremely sharp with a hedge against each other to perform the cutting action. The stationary blade or fixed knife 104 is affixed at the front of the frame 102. The reciprocating blade or movable knife 106 is adapted to move by actuation of the movable unit 110.

The rear blade 108 is disposed at the rear end 122 of the frame 102. The stationary blade 104 and the reciprocating blade 106 with the first cutting edge and the second cutting edge, respectively is configured to perform the cutting operation of the wood. The rear blade 108 comprising a splitting edge is configured to perform the splitting operation of the wood. Two or more wheels 114 are disposed beneath the frame 102 to facilitate movement and to provide stability to the device 100. In an embodiment, the stationary blade 104, the reciprocating blade 106 and the rear blade 108 is made of high-quality steel such as Hardox. In an embodiment, the cutting edge is designed to separate the log into two pieces. In an embodiment, the splitting edge is designed to sufficiently penetrate into an end of a log to be split so as to form a lengthwise crack in the log. In an embodiment, material dimensions of the device 100 are according to the thickness for which the device 100 is intended.

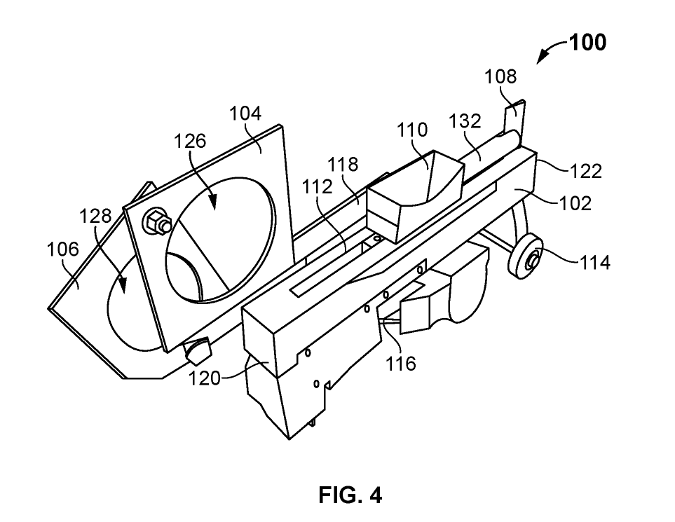

Referring to FIG. 2, the movable unit 110 is coupled to the reciprocating blade 106. The movable unit 110 is configured to move between the front end 120 and rear end 122 along a linear path 112 disposed on the frame 102. The drive means is configured to drive the movable unit 110 forward and rearward. The movable unit 110 is coupled to the reciprocating blade 106 via a shaft 118. A mechanical assembly 116 disposed at a side of the frame 102 configured to operate by a user to perform at least anyone of a cutting or splitting operation. In an embodiment, the mechanical assembly 116 could be a handle. The drive means drive the movable unit 110 forward for moving the reciprocating blade 106 so that the wood received in the first 126 and second aperture 128 is cut when said second cutting edge moves past the first stationary cutting edge. To perform splitting operation, the drive means moves the movable unit 110 rearward for pushing the wood piece 132, as shown in FIG. 4, received there along the path 112 to split by the splitting edge of the rear blade 108. In an embodiment, the shaft 118 is made of high-quality steel.

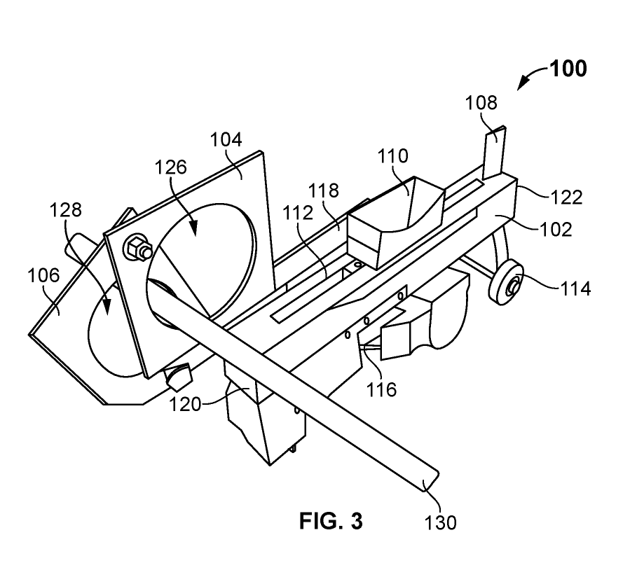

Referring to FIG. 3, the cutting operation of the wood performed by the wood chopper device 100 is disclosed. An appropriate length of wood 130 is fed into the stationary blade 104 and the reciprocating blade 106 in such a way the length of wood 130 extends from the first aperture 126 to the second aperture 128. Then the mechanical assembly 116 is operated by the user to initiate cutting operation of the wood. The drive means then moves the movable unit 110 forward, which in turn moves the reciprocating unit 106 via the shaft 118. When the movable knife or reciprocating blade 106 passes the stationary blade or fixed knife 104, the second cutting edge crosses the fixed first cutting edge to cut the wood placed therein the aperture (126, 128). The cutting edge of the blade (104, 106) is parallel with the piece of wood, and therefore the blade (104, 106) easily cuts the wood. Thus, a cutting effect occurs on the rotation, caused by a reciprocating knife 106 passing a stationary knife 104.

As the cutting-edge sinks further and further into the wood, the wood material on both sides of the blade (104, 106) is forced outwardly, against the blade (104, 106). Now the cutting edges of the stationary 104 and reciprocating blade 106 chops the wood into two pieces against the stationary blade 104. In this case the whole chopping process of the present invention prevents the device structures from suffering heavy impact strain. It is to be noted that the rotating speed of the blade (104, 106) is low. Also, the power demand is also comparatively small and, over all, the device 100 is safe to use.

Referring to FIG. 4, the splitting or slicing operation of the wood performed by the wood chopper device 100 is disclosed. A piece of wood 132 is placed along the linear path 112 at the rear end 122 of the frame 102. The user then operates the mechanical assembly 116 to move the movable unit 110 rearward, that is towards the rear blade 108 of the wood chopper device 100. The movable unit 110 forces the individual piece of wood 132 or log in the linear path 112 passageway against the splitting edge of the rear blade 108. The piece of wood 132 to be chopped is pushed against the rear blade 108. The splitting edge of the rear blade 108 hits the piece of wood 132 and begins to penetrate it. This operation enables splitting of the piece of wood 132. Advantageously, the power demand is comparatively small, as the cutting or splitting is based on pressing rather than hitting, as is the case in previously known devices. The present invention enables to achieve both cutting and splitting operation via the same device 100.

Preferred embodiments of this invention are described herein, including the best mode known to the inventors for carrying out the invention. It should be understood that the illustrated embodiments are exemplary only, and should not be taken as limiting the scope of the invention.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A wood chopper device for cutting and splitting wood, comprising:
a frame;
a stationary blade co-operating with a reciprocating blade disposed at a front end of the frame,
wherein the stationary blade having a first cutting edge along an edge of a first aperture disposed therein, and
wherein the reciprocating blade having a second cutting edge along an edge of a second aperture disposed therein;
a rear blade having a splitting edge disposed at a rear end of the frame;
a movable unit coupled to the reciprocating blade is configured to move along a linear path disposed on the frame; and
a drive means coupled to the movable unit,
wherein the drive means moves the movable unit forward for moving the reciprocating blade so that a length of wood received in the first and second aperture is cut when said second cutting edge moves past said first cutting edge, and
wherein the drive means moves the movable unit rearward for pushing a piece of wood there along the linear path to split by the splitting edge of the rear blade.

2. The wood chopper device of claim 1, wherein the frame having two or more wheels beneath the frame to facilitate movement and to provide stability to the chopper device.

3. The wood chopper device of claim 1, wherein the first aperture comprising at least any one a circular, rectangular or oval shape.

4. The wood chopper device of claim 1, wherein the second aperture comprising at least any one a circular, rectangular or oval shape.

5. The wood chopper device of claim 1, further comprising a mechanical assembly disposed at a side of the frame configured to operate by a user to perform at least anyone of a cutting or splitting operation.

6. The wood chopper device of claim 1, wherein the stationary blade, rear blade and reciprocating blade being made of steel.

7. The wood chopper device of claim 1, wherein the reciprocating blade being coupled to the movable unit by a shaft.
